(19) United States
(12) Patent Application Publication
(10) Pub. No.: US 2019/0152031 A1
(43) Pub. Date: May 23, 2019

(54) Wire Twister for Powered Driver

(71) Applicant: Jose Cordova, Uvalde, TX (US)

(72) Inventor: Jose Cordova, Uvalde, TX (US)

(21) Appl. No.: 15/817,278

(22) Filed: Nov. 19, 2017

(51) Int. Cl. B25B 25/00; H01R 4/12

(52) U.S. Cl. CPC B25B 25/00; H01R 4/12

(57) ABSTRACT

A wire twisting device for use with a typical power driver, in the shape of a plate whereby the wires can be engaged by the device by sliding the wires through cut-outs in the outer edge of the plate to a respective port appropriately sized to accept the wire and hold in place until driver can be engaged to twist the wire into the desired braided position, connecting the wires and allowing a junction to be completed by the user.

### BACKGROUND OF THE INVENTION

The present invention generally relates to the field of devices utilized for electrical wire twisting. Electrical cables and wires used in residential, commercial and industrial building applications generally consist of a plurality of individual wires that must be twisted to promote efficient and safe joinder at junctions. Additionally, cables are often constructed with the plurality of wires in a twisted formation that must be un-twisted prior to creating a joinder with a second wire at a junction.

The creation of a wire junction typically consists of exposing each end of the two wires and then twisting the two ends prior to capping the newly created junction. This motion can place significant stress on the fingers of the electrician or person creating the junction if creating the junction without a tool. While a variety of tools exist to aid in the twisting of the wires, these are often clumsy or time consuming and still require the user to manually twist the wires together.

Currently there exist in the art several devices that utilize a powered device, such as a driver or drill, to aid in the creation of junctions by using power to twist the wires in junction creation. These devices still require the user to feed the wire through a hole only slightly larger than the gage of the wire for successful use. The present invention represents a market improvement on the existing art.

### BRIEF SUMMARY OF THE INVENTION

The present invention, in the preferred embodiment, eliminates the need to feed a wire through a hole in the device. In the preferred embodiment, the present invention comprises a circular plate with notches or grooves in which the wires can be slid in from the side of the device rather than being fed through a small hole. This improvement places significantly less strain on the user's hands and allows for a more efficient use of the device. It requires less time to slide the wires into placement in the invention than feeding the wires through the small holes as is required in the existing art. Furthermore, a single device can accommodate a range of gages of wires by tapering the notches or grooves from a larger width near the outer edge of the circular plate to a smaller width as the notch gets closer to the center of the plate. Additionally, the use of notches or grooves and sliding motion rather than feeding through a hole, places less strain on the user's hands and requires less precision in the vision of the user as he or she attempts to utilize the invention. Particularly when twisting wires of higher gage and a smaller diameter, seeing the hole in the existing art and feeding the wire through the hole can be challenging and time consuming for some users. The present invention virtually eliminates this issue.

### BRIEF DESCRIPTION OF THE DRAWINGS

FIG. 1 is a top down view of the present invention. The grooves in the device, 107, allow for the wire to be slid into place. The notches, 102, 103 and 104, are sized to allow wire of a plurality of gauges or sizes to be held in place.

FIG. 2 is a side view of the present invention. The grooves are shown as 107.

### DETAILED DESCRIPTION OF THE INVENTION

The present invention is a tool, able to be secured to a typical power drill or driver, for the purpose of twisting together a plurality of electrical wire, stripped of any protective coating, to create a junction of said plurality of wires by twisting the wires together prior to applying a covering or other item to protect the newly formed wire junction.

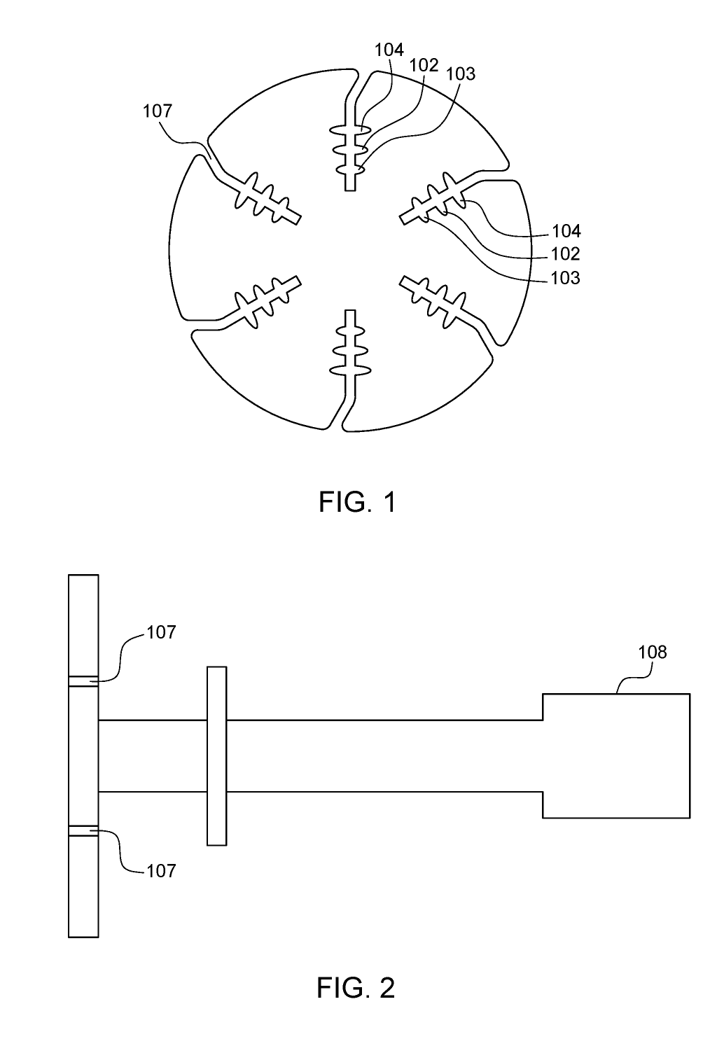

In the preferred embodiment, the present invention is comprised of a top piece, in the shape of a plate, or plate, shown in FIG. 1, and an attached rod, 108 in FIG. 2, for the purpose of securing the plate to the typical power drill or driver. The plate section has a plurality of groves, 107, cut into the plate from the outer edge of the plate inward to allow a wire to be slid into position for the twisting process. FIG. 1 shows the present invention with six grooves, 107, however the number of grooves can be increased or decreased in alternative embodiments, depending on the size of the invention and the needs of the particular user.

In the preferred embodiment, the present invention in FIG. 1 depicts 3 notches, labeled 102, 103 and 104, that are used to hold the wire in place for the twisting the process. It is currently known in the art a similar device with holes instead of notches that serve a similar purpose. The advantage of the present invention is the combination of the grooves, 107, and the notches, 102, 103 and 104, that allow the wire to be slid into place from the side of the plate, rather than fed through a small hole from the bottom of the plate as required in existing devices.

In the preferred embodiment, there are three notches in the plate, 102, 103 and 104, are of differing sizes to account for the different thickness of typical wire used in the electrical industry. The first notch, 104, is closest to the outer edge of the plate and is the largest size notch. This would accommodate the largest gauge wire. The second notch, 102, is smaller than the first notch, 104, and the third notch, 103 is the smallest of the three notches accommodating the smallest gauge wire of the particular embodiment of the present invention. An alternative embodiment of the invention can have more or less notches, depending on the size of the invention and to account for the needs of the particular user.

The side view, FIG. 2, depicts the present invention in the preferred embodiment and shows the notches, 107, in the plate. The end of the rod, 108, distal to the plate section, is the tool engaging face, allowing a typical power drill or driver to securely, but temporarily, attach to invention for use.

To utilize the present invention in the preferred embodiment, a user will have at least two wires that need to be twisted together to form a junction or connection, typically preformed in the electrical industry. With the protective covering removed from the end of the wires, the user would slide the exposed metal wire in at least two of the plurality of grooves, 107, until reaching the notch, 102, 103 or 104, that is best suited to the size of the particular gauge wire being used. The present invention would likely be marked to inform the user as to the gauge of wire able to be accommodated by the particular embodiment of the present invention. The largest gauge wire able to be accommodated would fit securely into the notch closest to the outer edge of the plate, 104, and the smallest gauge wire able to be accommodated would fit securely into the notch furthest from the outer edge of the plate, 103. The number of notches could be increased from three to allow the user to utilize the same embodiment of the present invention on a larger range of wire gauges. The number of grooves could also be increased as needed to be able to twist more than six individual pieces of wire together. The preferred embodiment of the present invention depicts six grooves, 107 and three notches, 102, 103 and 104. This depiction is not meant to the limit the number of grooves or notches.

We claim:

1. A wire twisting device comprising:
a plate having a wire engaging face, a tool engaging face, a plurality of grooves cut out from the outer edge of the plate, equidistant from each other, toward the center of the plate and a plurality of circular-shaped ports positioned in line with the grooves whereby the grooves are enlarged by the circular-shaped ports;
a shaft operably connected to the plate such that the rotation of the shaft is imparted to the plate;
wherein each of the plurality of ports are configured to substantially engage a wire.

2. The wire twisting device of claim 1, wherein the ports are positioned to engage and arrange the wire snugly and equidistant from each other.

3. The wire twisting device of claim 1, wherein the shaft is configured to operably connect to the chuck of an electrical driver.

4. The method for twisting electrical wire, comprising:
providing a wire twisting device having a plate having a wire engaging face, a tool engaging face, a plurality of grooves cut out from the outer edge of the plate, equidistant from each other, toward the center of the plate and a plurality of circular-shaped ports positioned in line with the grooves whereby the grooves are enlarged by the circular-shaped ports, and a shaft operably connected to the plate such that the rotation of the shaft is imparted to the plate with the end of the shaft distal to the plate able to operably connect to the chuck of a typical electric driver;
engaging a plurality of wires in the ports equidistant from each other by sliding the wire from the side of the plate into the groove and into position at the appropriately sized port;
rotating the twisting device by engaging the typical electric driver;
twisting the respective wires together to a form a braided wire segment; and
disengaging the braided wire segment from the wire twisting device.
